(19) United States
(12) Patent Application Publication
(10) Pub. No.: US 2007/0155226 A1
(43) Pub. Date: Jul. 5, 2007

(54) External power supply connector

(76) Inventor: Patrick Chen, Hsin-Tien City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/473,230

(22) Filed: Jun. 23, 2006

(30) Foreign Application Priority Data
Jan. 3, 2006 (TW) 095100227

(51) Int. Cl. H01R 13/73

(52) U.S. Cl. 439/544

(57) ABSTRACT

An external power supply connector for a computer system includes a power outlet installed on the computer system for supplying power to an external peripheral device coupled thereto, and a first power transmission port installed on the power outlet coupled to a second power transmission port of a power supply unit of the computer system. The power outlet is coupled electrically to a power supply unit for transmitting a single-voltage power source or a multiple-voltage power source, which is compliant to the power specifications required by external peripheral devices, to the external peripheral devices.

### FIELD OF THE INVENTION

The present invention relates to a connector, and particularly to an external power supply connector used in a computer system.

### BACKGROUND OF THE INVENTION

With advancement in technology of computer systems, external peripheral devices, such as external hard disk drives and external CD-ROM drives, of the computer systems are more popular. Nowadays, universal serial bus (USB) plugs are generally installed on external peripheral devices for connecting to the USB sockets of the computer systems. Because the data rate of USB reaches 480M bites per second as well as supporting hot-plug, USB has become the most popular transmission interface between the computer systems and the external peripheral devices. In general, USB only permits transmitting power of 5 Volts and 500 mA to external peripheral devices. However, as the performance of external peripheral devices gets higher and higher, the required current of the external peripheral devices of the USB gets higher as well, which even exceeds the rated current of the USB. In such circumstance, if the required power for such high-current external peripheral devices is supplied only by the USB, the high-current external peripheral devices will suffer from reduced performance and stability due to lack of current. Even worse, it will cause the high-current external peripheral devices unworkable.

For solving the problems described above, as shown in FIG. 1, a USB plug 12 is disposed on an external peripheral device 10 for mating with a USB socket fixed in a computer system 20. In addition, an adapter 14 is provided for converting alternating currents (AC) from a power outlet 15 to direct currents (DC) required by the external peripheral device 10. However, using the adapter 14 to supply power is quite inconvenient because the users could not use the external peripheral device 10 without the power outlet 15. Moreover, the adapter 14 occupies certain amount of space, which is unwanted for the users.

FIG. 2 is a block diagram illustrating another conventional power supplying architecture comprising an external peripheral device 10 with required currents and a plurality of USB plugs 12 assembled to the external peripheral device 10 with high current demand for plugging to USB sockets 22. For example, if the current required by the external peripheral device 10 is 500 mA, a USB plug 12 is needed to be installed on the external peripheral device 10; if the current required by the external peripheral device 10 is 1000 mA, two USB plugs 12 are needed to be installed. Thus, it can be seen that the higher the current required by the external peripheral device 10, the more USB plugs 12 are needed to be installed. Therefore, multiple USB sockets 22 of the computer system 20 will be occupied, which keeps the computer system 20 from installing multiple external peripheral devices 10, especially for notebook computers.

Currently, in order to increase the transmission rate of internal peripheral devices in a computer system, a variety of next-generation transmission interfaces has been proposed continually. However, some of the transmission interfaces of the peripheral devices adopt multiple-voltage power specifications, which are different from normal peripheral devices requiring single voltage only. For example, Serial Advanced Technology Attachment (SATA), require 5 Volts and 12 Volts simultaneously. Consequently, it is still a problem to supply multiple-voltage power to the exteriors of current computer systems or exteriors of power supply units of the computer systems. Based on the reasons described above, some of the advanced next-generation transmission interfaces still cannot widely applied in the external peripheral devices, which is really a great loss for the users.

Accordingly, it is necessary to provide an external power supply connector of a computer system, which is able to supply power required by different external peripheral devices to improve the convenience for users using the external peripheral devices.

### SUMMARY

The purpose of the present invention is to provide an external power supply connector connecting with external peripheral devices and being capable of transmitting power compliant to the power specifications of external peripheral devices.

Another purpose of the present invention is to provide an external power supply connector of a computer system able to prevent incorrect power transmission to external peripheral devices coupled thereto.

For achieving above objects, a power supply connector used for a computer system in accordance with the present invention comprises a power outlet installed on the computer system for supplying power to an external peripheral device coupled thereto. The power outlet defines a first power transmission port coupled to a second power transmission port of a power supply unit of the computer system. The power outlet is coupled electrically to a power supply unit for transmitting a single-voltage power source or a multiple-voltage power source, which is compliant to the power specifications of external peripheral devices, to the external peripheral devices. Furthermore, the power outlets and power plugs disposed in the external peripheral devices with the same power specifications respectively have plugging slots and metal conductors configured in corresponding geometric shapes, for preventing the power plugs from being mistakenly inserted to the power outlets with different power specifications. Thereby, the users can conveniently use external peripheral devices with various power specifications.

In order to make the structure and characteristics as well as the effectiveness of the present invention to be further understood and recognized, the detailed description of the present invention is provided as follows along with preferred embodiments and accompanying figures.

### BRIEF DESCRIPTION OF THE DRAWINGS

FIG. 1 is a block diagram illustrating a conventional power supplying architecture;

FIG. 2 is a block diagram illustrating another conventional power supplying architecture;

FIG. 3 is a schematic diagram of structure according to the first embodiment of the present invention;

FIG. 4 is a schematic diagram of structure according to the second embodiment of the present invention;

FIG. 5 is a schematic diagram of structure according to the third embodiment of the present invention;

FIG. 6 is a schematic diagram of structure according to the fourth embodiment of the present invention; and

FIG. 7 is a schematic diagram of structure according to the fifth embodiment of the present invention.

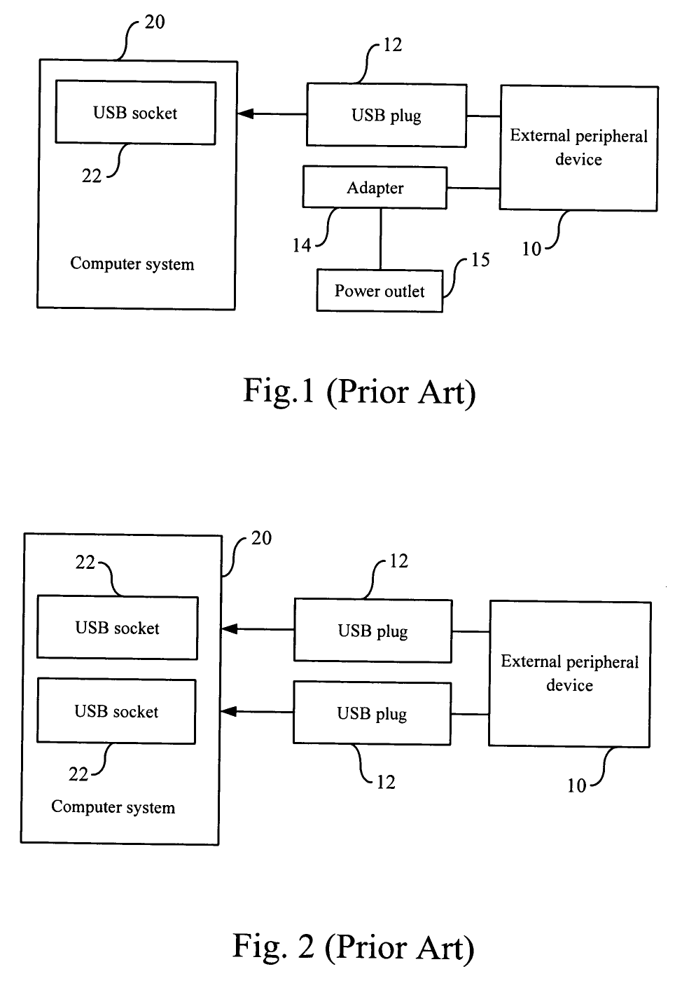

### DETAILED DESCRIPTION

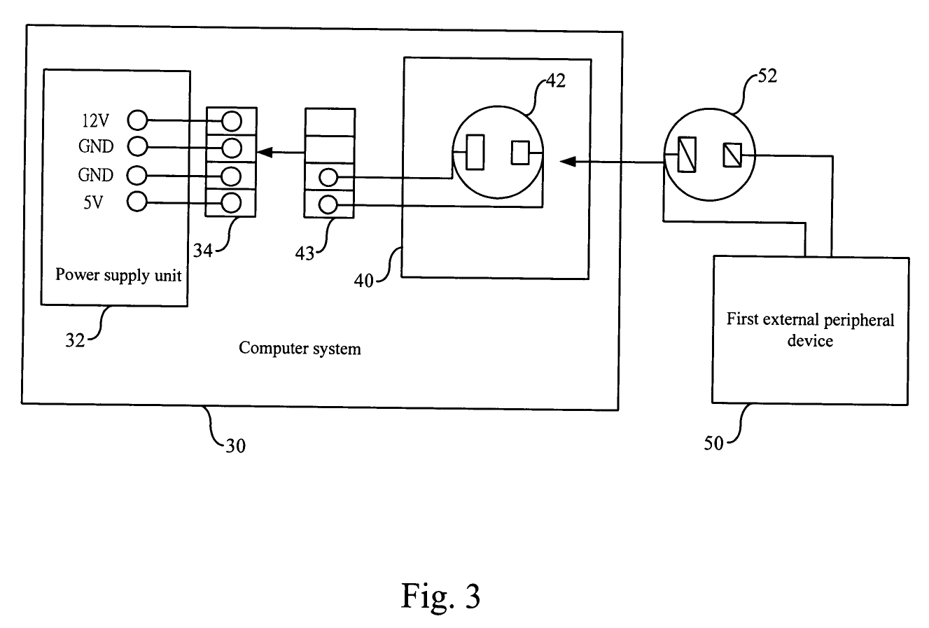

Please refer to FIG. 3, which is a schematic diagram of structure according to the first embodiment of the present invention. As shown in the figure, a first power outlet 42 is assembled on a computer system 30 and is exposed to the exterior of a case 40 for convenience of use. The location of the first power outlet 42 can be exposed to the panel of the case 40, or to any exterior position of the case 40 according to the shape of the case 40. The first power outlet 42 defines a first power transmission port 43 matable with a second first power transmission port 34 of a power supply unit 32 for transmitting power supplied by the power supply unit 32 to the first power outlet 42. The first power outlet 42 according the present embodiment is assigned to transmit 5-Volt power via the first power transmission port 43. In addition, a first power plug 52 is installed on a first external peripheral device 50 using the power specification of 5 Volts for mating with the first power outlet 42, the 5-Volt power thus can be transmitted to the first external peripheral device 50. The first external peripheral device 50 can be a universal serial bus (USB) device.

In the present invention, since the power of the first external peripheral device 50 is directly supplied by the power supply unit 32 via the electrical connection of the first power outlet 42 and the first power plug 52, the stability of power supplying to the first external peripheral device 50 could be assured. Thereby, the problem in prior arts that adapters or a plurality of USB sockets have to be used to supply the high current required by the first external peripheral device 50 can be solved. That is to say, users can simultaneously use multiple external peripheral devices with high rated current without worry of occupying large amounts of space.

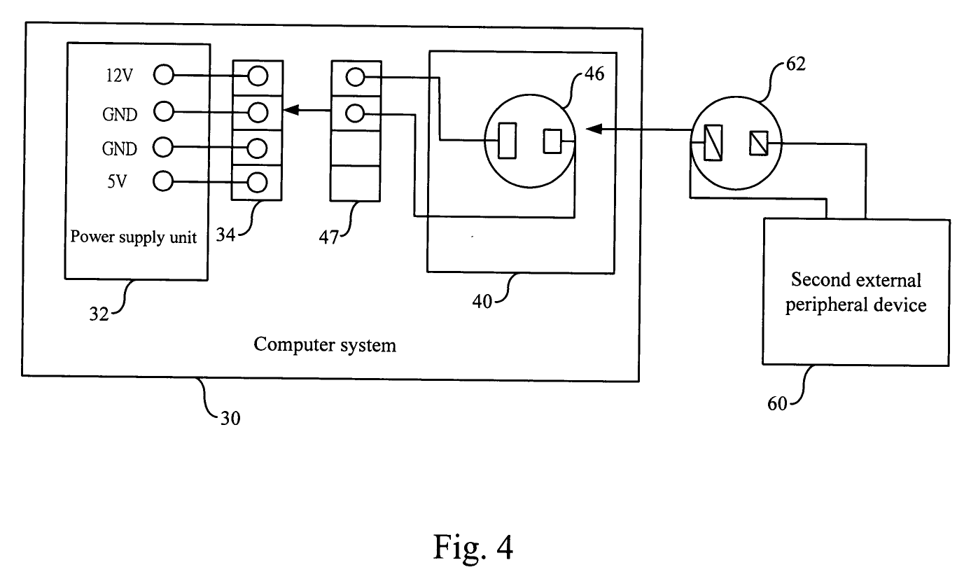

Please refer to FIG. 4, which is a schematic diagram of structure according to the second embodiment of the present invention. The difference between the embodiments in FIG. 3 and FIG. 4 is that the first power transmission port 43 of the embodiment in FIG. 3 transmits 5-Volt power to the first power outlet 42, while the first power transmission port 47 of the embodiment in FIG. 4 transmits 12-Volt power to a second power outlet 46. In other words, the second power outlet 46 is used to transmit 12-Volt power while the first power outlet 42 is used to transmit 5-Volt power. Likewise, the second power outlet 46 is electrically coupled to the computer system 30 for transmitting power from the power supply unit 32, and is exposed to the exterior of the case 40. Thereby, when using a second external peripheral device 60 with 12-Volt power specifications, the required voltage and current of 12-Volt power can be acquired through electrical connection of a second power plug 62 and the second power outlet 46.

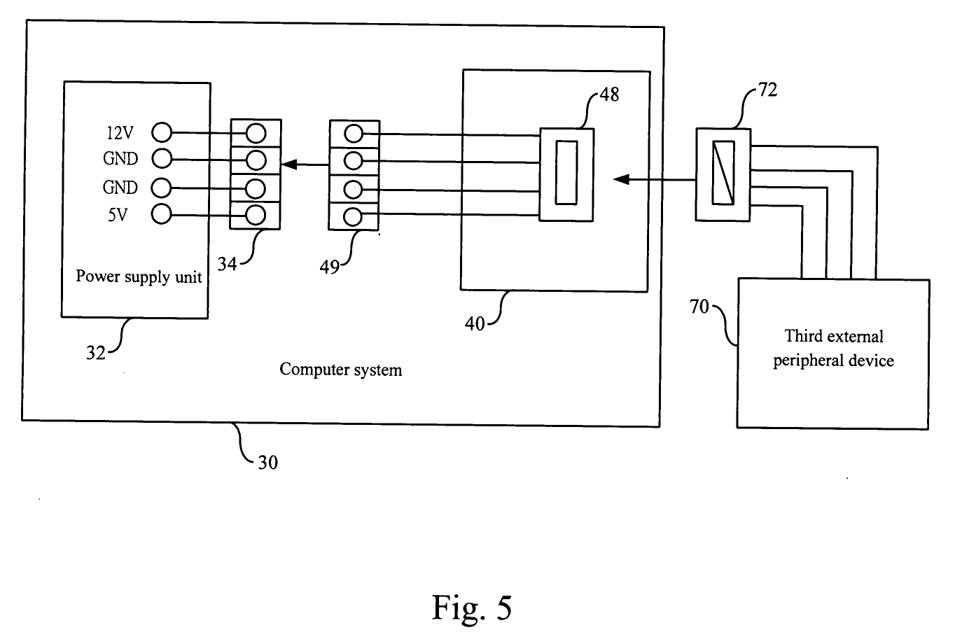

Next, according to the present invention, how to transmit power with multiple voltages to external peripheral devices with multiple specified voltages will be described. Particularly, an external peripheral device complied with specification of Serial Advanced Technology Attachment (SATA) is taken as an example of the external peripheral device with multiple specified voltages in the following description. As shown in FIG. 5, a third power plug 72 is assembled on a third external peripheral device 70 of SATA, and there is a corresponding third power outlet 48 on the exterior of the case 40 of the computer system 30. Because the power specifications of the third external peripheral device 70 are 5 Volts/12 Volts, the first power transmission port 49 installed on the third power outlet 48 is capable of transmitting power of 5 Volts/12 Volts to the third power outlet 48. Likewise, the third power outlet 48 is electrically coupled to the computer system 30 for transmitting power from the power supply unit 32, and is exposed to the exterior of the case 40. When users wish to use the third external peripheral device 70, they only need to plug the third power plug 72 to the third power outlet 48, and the power of 5 Volts/12 Volts will be transmitted to the third external peripheral device 70. Furthermore, as the power of 5 Volts/12 Volts transmitted to the third external peripheral device 70 is supplied by the power supply unit 32 via the third power outlet 48, the currents of the power of 5 Volts/12 Volts are also compliant to the currents specification of the third external peripheral device 50.

According to the embodiments described above, it should be acknowledged that the power outlet can stably transmit higher-current power to the external peripheral devices because power is supplied to the power outlet of the computer system 30 by the power supply unit 32 of the computer system 30. In addition, according to the present invention, as the power supply unit 32 is able to supply power with various specifications, external peripheral devices with different power specifications could be applied by providing power outlets with various power specifications in consistence with those of the external peripheral devices. Consequently, users can use the external peripheral devices conveniently with absence of conventional power adapters. Moreover, the next-generation transmission interfaces can be gradually popularized to the external peripheral devices for improving performance of the external peripheral devices. Furthermore, the present invention also can be applied to other electronic devices such as battery chargers and table lamps, but each of such electronic devices has to provide a power plug connectable with the power outlet disclosed in the present invention for power transmission.

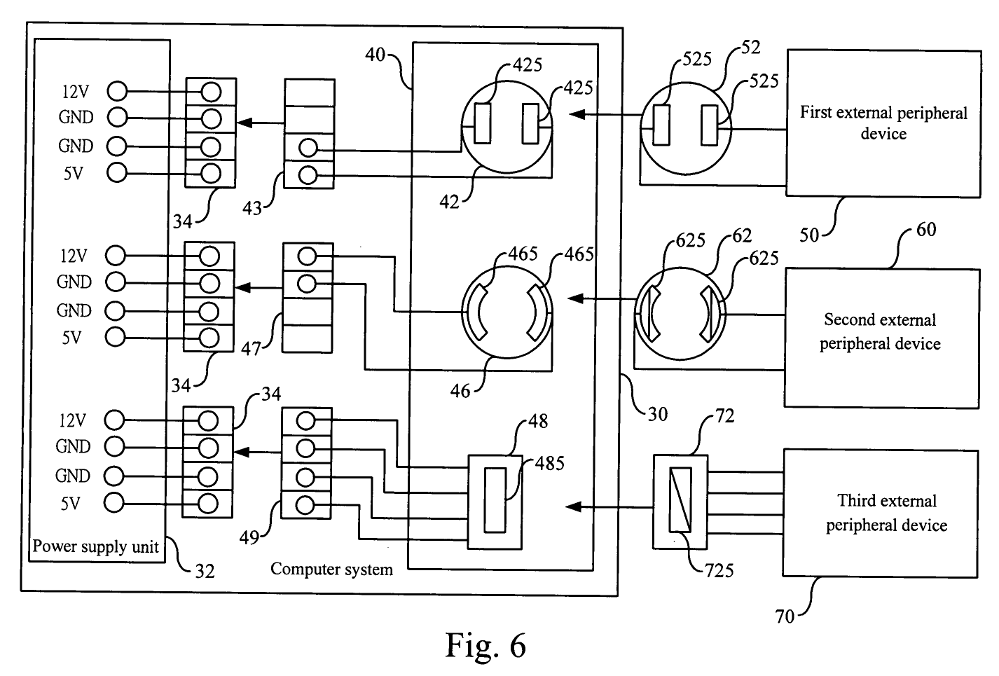

Please refer to FIG. 6, which is a schematic diagram of structure according to the fourth embodiment of the present invention. The computer system 30 shown in FIG. 6 comprises three power outlets 42, 46, 48 of three different power specifications for connecting with three power plugs 52, 62, 72 of external peripheral devices 50, 60, 70 with different power specification, respectively. The power outlets 42, 46, 48 are coupled electrically to the computer system 30 respectively, and are exposed to the exterior of the case 40, so that power can be transmitted individually from the power supply unit 32. To prevent the power plugs 52, 62, 72 from miss-mating with the power outlets 42, 46, 48 with different power specifications, the geometric shapes of slots 425, 465, 485 of the power outlets 42, 46, 48 are different from each other. Correspondingly, the geometric shapes of the metal conductors 525, 625, 725 of the power plugs 52, 62, 72 are the same as those of the slots 425, 465, 485. Thereby, the power plugs 52, 62, 72 can only be inserted to the power outlets 42, 46, 48 with the same power specifications, preventing the external peripheral devices from being inoperable or other undesired impact caused by the miss-mating of the power plugs 52, 62, 72 and the power outlets 42, 46, 48.

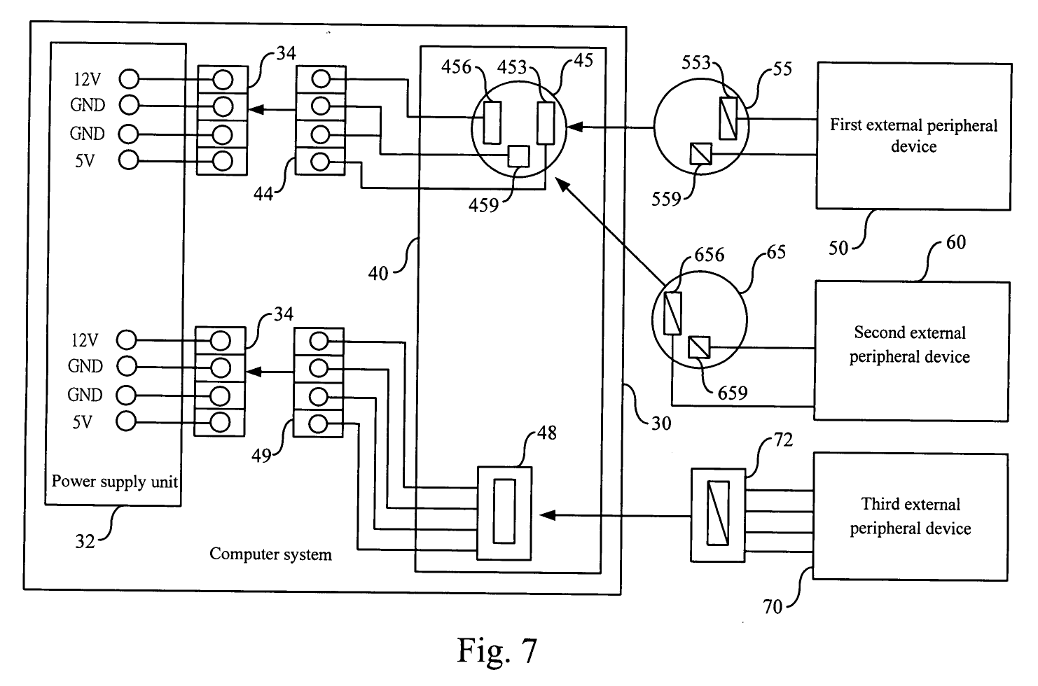

Please refer to FIG. 7, which is a schematic diagram of structure according to the fifth embodiment of the present invention. The difference between the embodiments in FIG. 6 and FIG. 7 is that the first power transmission port 43 in FIG. 6 transmits 5-Volt power only to the first power outlet 42, while the first power transmission port 44 in FIG. 7 transmits both 5-Volt and 12-Volt power to the first power outlet 45. In addition, the first power outlet 45 is a three-slot socket. The positions and the geometric shapes of the metal conductors 553, 559 of the first power plug 55 are the same as the slots 453, 459 of the first power outlet 45. The positions and the geometric shapes of the metal conductors 656, 659 of the second power plug 65 are the same as the slots 456, 459 of the first power outlet 45. Thus, both of the first power plug 55 and the second power plug can be plugged into the first power outlet 45 to transmit 5-Volt or 12-Volt power respectively.

Although both of the first power plug 55 and the second power plug 65 can be plugged to the first power outlet 45, the positions of the metal conductors 553, 656, used for conducting and transmitting power, of the first power plug 55 and the second power plug 65 are different. That is, the positions of the corresponding slots 453, 456, which the metal conductors of the first power plug 55 and the second power plug 65 plug to, are different. Thereby, even if the slots 453, 456 are configured in the same shape, the metal conductor 553 of the first power plug 55 is unable to be inserted into the slot 456 of the first power outlet 45 because of different positions. Likewise, the second power plug 65 will not be plugged wrongly. In this way, the power connecter disclosed in the present invention could prevent incorrect power transmission to the first and second external peripheral devices 50, 60 caused by unaware miss-mating.

Such kind of universal-type first power outlet 45 comprises a grounding slot 459 shared by the first and second power plugs 55, 65 and two distinct slots 453, 456 for transmitting power with different specifications, whereby the first power plug 55 and the second power plug 65 can share the first power outlet 45 jointly. In order to make sure that the first power plug 55 and the second power plug 65 inserted into the slots 453, 456 of the first power outlet 45 correctly, the slots 453, 456 can be configured in different shapes. In some applications, another power outlet, just as same as the first power outlet 45, should be provided so that the first external peripheral device 50 and the second external peripheral device 60 could be operated simultaneously.

The external power supply connector of the present invention includes a power outlet installed in the computer system and electrically coupled to a power supply unit of the computer system, and the power outlet transmits the required power to a correspondingly external peripheral device. Thereby, users only need to connect the external peripheral device to the power outlet on the exterior of the computer system, and then power can be transmitted from the power outlet to the external peripheral device. Furthermore, because power is supplied by the power supply unit of the computer system, power required by external peripheral devices can be supplied stably, and power with multiple specifications can be supplied.

Accordingly, the present invention conforms to the legal requirements owing to its novelty, unobviousness, and utility. However, the foregoing description is only a preferred embodiment of the present invention, not used to limit the scope and range of the present invention. Those equivalent changes or modifications made according to the shape, structure, feature, or spirit described in the claims of the present invention are included in the appended claims of the present invention.

1. An external power supply connector, comprising:
a power outlet installed on the computer system and exposed from an exterior of a case of the computer system and supplying a single-voltage power source or a multiple-voltage power source to an external peripheral device coupled thereto; and
a first power transmission port installed on the power outlet, and coupled to a second power transmission port of a power supply unit of the computer system.

2. The external power supply connector of claim 1, wherein the power outlet is exposed from a panel of the case.

3. The external power supply connector of claim 1, wherein a power plug is installed on the external peripheral device for plugging to the power outlet.

4. The external power supply connector of claim 1, wherein the external peripheral device is an external peripheral device of USB.

5. The external power supply connector of claim 1, wherein the external peripheral device is an external peripheral device of SATA.

6. The external power supply connector of claim 1, wherein the single-voltage power source is a 5-Volt power source.

7. The external power supply connector of claim 1, wherein the single-voltage power source is a 12-Volt power source.

8. The external power supply connector of claim 1, wherein the multiple-voltage power source is a 5-Volt/12-Volt power source.

9. The external power supply connector of claim 1, wherein the power supply connector is composed of a plurality of the power outlets installed on the computer system, each power outlet has a first power transmission port coupled to the second power transmission port for transmitting power with different specifications respectively.

10. The external power supply connector of claim 9, wherein each power outlet sets up a plurality of slots according to power specifications, and a power plug of the external peripheral device sets up a plurality of metal conductors for matching the slots on the power outlets respectively.

11. An external power supply connector, comprising:
a power outlet installed on the computer system and exposed from the exterior of a case for plugging by a power plug of an external peripheral device, and coupled to a power supply unit of the computer system for supplying a required power of a single voltage power source or a multiple voltage power source to the external peripheral device.

12. The external power supply connector of claim 11, wherein the power outlet is exposed from a panel of the case.

13. The external power supply connector of claim 11, wherein the external peripheral device is an USB external peripheral device.

14. The external power supply connector of claim 11, wherein the external peripheral device is a SATA external peripheral device.

15. The external power supply connector of claim 11, wherein the single-voltage power source is a 5-Volt power source.

16. The external power supply connector of claim 11, wherein the single-voltage power source is a 12-Volt power source.

17. The external power supply connector of claim 11, wherein the multiple-voltage power source is a 5-Volt/12-Volt power source.

18. The external power supply connector of claim 11, wherein the power supply connector is composed of a plurality of the power outlets installed on the computer system, and every power outlet are coupled to the power supply unit for transmitting power with different specifications respectively.

19. The external power supply connector of claim 18, wherein each power outlet sets up a plurality of slots according to power specifications, and a power plug of the external peripheral device sets up a plurality of metal conductors for matching the slots on the power outlets respectively.
